(19) United States
(12) Patent Application Publication
(10) Pub. No.: US 2011/0002139 A1
(43) Pub. Date: Jan. 6, 2011

(54) LIGHT PIPE

(76) Inventor: Kang-Hoon Lee, Gyeongsangnam-do (KR)

Correspondence Address: NELSON MULLINS RILEY & SCARBOROUGH LLP;FLOOR 30, SUITE 3000, ONE POST OFFICE SQUARE, BOSTON, MA, 02109, US

(21) Appl. No.: 12/866,109

(22) PCT Filed: Jan. 20, 2009
(86) PCT No.: PCT/KR09/00296

§ 371 Date: Aug. 4, 2010

(30) Foreign Application Priority Data
Feb. 4, 2008 (KR) 10-2008-0011150
Apr. 30, 2008 (KR) 10-2008-0040602

(51) Int. Cl. F21V 9/00; G02B 6/00

(52) U.S. Cl. 362/583; 362/551

(57) ABSTRACT

Disclosed is a light pipe including a body having a hollow therein, and plural prism sections on an outer surface of the body. Each prism section includes a reflection section, a cross section of which is an isosceles right triangle, and an angle adjusting section. The angle adjusting section has a cross section in the shape of a right-angled triangle, a base side of which is an oblique side of the isosceles right triangle. A vertical angle of the right-angled triangle varies with the position of a light source. Installation of the light source at the center of the cross section of the light pipe is not required, thereby increasing the manufacturing efficiency of the light pipe. The light pipe has an internal surface in various shapes including a cylindrical shape to be applicable to various application fields. Power is saved, and light is transmitted to a remote place.

### BACKGROUND OF THE INVENTION

1. Field of the Invention

The present invention relates to a light pipe, and more particularly to a light pipe using total internal reflection.

2. Description of the Related Art

In general, a light pipe is an optical member to transmit light emitted from a light source to a remote plate with relatively low light loss or effectively distribute decorative functional light into a wider area, and includes a light conduit, a light guide, or a light tube.

The structure of the light pipe is made of a transparent polymer, and the light pipe includes an outer surface having a fine structure and a wall having the shape of a tube having a smooth internal surface opposite to the outer surface. The outer surface includes a plurality of linear prisms having the same shape while extending lengthwise along the light pipe.

The light pipe allows light ray incident into the light pipe within a predetermined angle to travel through total internal reflection, thereby transmitting the light ray to a remote plate along the inside of the light pipe.

FIGS. 1 to 3 are views showing a light pipe according to the related art.

FIG. 1 is a sectional view showing the path of light ray along a cylindrical light pipe employing triangular prisms according to the related art, and FIG. 2 is an enlarged sectional view showing the path of light ray when the light pipe employing the triangular prisms has an internal flat surface according to the related art. FIG. 3 is a sectional view showing the range of total reflection in a rectangular-prism-shape light pipe employing the triangular prisms according to the related art.

Referring to FIG. 1, alight source 12 is located at the center of a cross section of a cylindrical light pipe 10 having triangular prisms according to the related art. Light ray 14 emitted from the light source 12 is directed in a radial direction to form an angle of 90° with an internal surface of the cylindrical light pipe 10. Accordingly, the incident angle of the light ray 14 forms an angle of 0° with a normal line to the internal surface, so that the light ray 14 is not refracted, but introduced into triangular prisms 16.

The light ray 14 introduced into the triangular prisms 16 is subject to total internal reflection on a triangular prism surface 18 so that the path of the light ray 14 is changed. The above procedure is repeated, so that light is transmitted with lower light loss along the inside of the cylindrical light pipe 10.

If the light source 12 is positioned off the center of the cross section, the total reflection does not occur on the triangular prism surface 18. Accordingly, a great amount of light ray is emitted to the outside of the light pipe, so that transmission efficiency may be degraded.

Hereinafter, description will be made regarding the range and the cause in which total reflection does not occur when the light pipe 10 employing the triangular prisms 16 according to the related art has an internal flat surface.

Referring to FIG. 2, when a normal line 22 to an internal surface 20 of the light pipe 10 forms an angle A with the light ray 14 that is incident into the internal surface 20, an angle B is obtained through Equation 1 under Snell's Law. In Equation 1, n represents a refractive index of the light pipe 10.

$$B = arcsin ( \frac{sin A}{n} ) \qquad Equation 1$$

In FIG. 2, if an angle P is 90°, an angle D is 135° regardless of the value of A. Accordingly, an angle C formed between a normal line 24 to the triangular prism surface 18 and the light ray 14 is equal to 45°-B.

In addition, if the refractive index n of the light pipe 10 is about 1.57, a critical angle θ_{c} becomes 39.56°. Therefore, the light ray 14 is not subject to total reflection, but emitted to the outside if the angle C is 39.56° or less.

Accordingly, through following Equation 2, if the refractive index of the light pipe 10 is about 1.57, and if the angle A between the normal line 22 to the internal surface 20 of the light pipe 10 and the light lay 14 is about 8.56° or more, the light ray 14 is not subject to total reflection inside the light pipe 10, but emitted to the outside.

$$45 - arcsin ( \frac{sin A}{n} ) \leq 39.56 \qquad Equation 2$$

Referring to FIG. 3, in the case of a rectangular-prism-shape light pipe employing triangular prisms according to the related art, only light ray, which is incident into the internal surface 20 from the light source 12 positioned at the center of the cross section of the light pipe while forming an angle of about 8.56° or less with the normal line 22 to the internal surface 20 of the light pipe, is total-reflected. Accordingly, the total reflection may occur only in sections 26, 28, 30, and 32 in which the light ray forms the angle of about 8.56° or less with the normal line 22 to the internal surface 20 of the light pipe. In the remaining sections, the light ray is emitted out of the internal surface 20 like light ray I. Accordingly, if the light pipe employing the triangular prisms according to the related art has an internal flat surface, light ray emitted from a light source 12 is not total-reflected continuously inside the light pipe, but emitted to the outside.

However, the related art has following problems.

In other words, if an internal surface of a light pipe has a cylindrical shape, and if a light source is positioned off the center of a cross section of the light pipe, an amount of light traveling through total-reflection on the internal surface of the light pipe is significantly reduced. Accordingly, the position of the light source cannot be freely set.

In addition, if the internal surface of the light pipe has the shape of a polygonal prism according to the related art, since the range of an incidence angle allowing the light ray emitted from the light source to travel while being total-reflected is narrowed, light cannot be effectively transmitted.

If a fluorescent signboard according to the related art is employed, a greater amount of light is wasted while being absorbed into a surface sheet to uniformly distribute light of a fluorescent lamp, so that power consumption may be increased.

### SUMMARY OF THE INVENTION

Accordingly, the present invention has been made to solve the above-mentioned problems occurring in the prior art. An object of the present invention is to provide a light pipe capable of effectively transmitting light and freely setting the position of a light source.

Another object of the present invention is to provide alight pipe capable of effectively transmitting light even if the internal surface of the light pipe does not have a cylindrical shape.

In order to accomplish the above objects, there is provided a light pipe. The light pipe includes a body provided therein with a hollow extending lengthwise along the body, and a plurality of prism sections extending lengthwise along the body on an outer surface of the body. Each prism section includes a reflection section, a cross section of which is an isosceles right triangle, and an angle adjusting section interposed between the body and the reflection section.

A cross section of the angle adjusting section is a right-angled triangle having an oblique side in contact with the body and a vertical angle interposed between the body and the reflection section in which a size of the vertical angle is determined according to a position of a light source.

In addition, a cross section of the angle adjusting section is an isosceles triangle that has two sides having a same length in contact with the body and the reflection section and a vertical angle interposed between the body and the reflection section in which a size of the vertical angle is determined according to a position of a light source.

The size of the vertical is equal to a size of a refracted angle obtained when light ray emitted from the light source travels in parallel to a cross section of the light pipe, is indent into an internal surface of the body, and refracted.

The vertical angle satisfies an equation,

$$G = arcsin ( \frac{sin E}{n} ) ,$$

in which G, n, and E represent the vertical angle, a refractive index of the light pipe, and an incident angle when the light ray emitted from the light source travels in parallel to the cross section of the light pipe and incident into the internal surface of the body, respectively.

The light pipe further comprises a filter section to transform a color of light emitted from the light source. The filter section includes a reflector to reflect the light ray emitted from the light source, a color filter provided at a front of the reflector, including at least one coloring layer, and having a light transmission property, and a motor to rotate the color filter.

The hollow has a polygonal shape.

The prism section satisfies an equation,

L=h tan [arcsin(n sin(G+k)−arcsin(n sinG)], (G=0, k, 2k, 3k, . . . , and N)

In this Case, G Represents the Vertical Angle, L Represents a length of duration in the body having the angle adjusting section with the vertical angle G, h represents a distance between the light source to a point corresponding to an incident angle of 0° into the internal surface of the body, n represents a refractive index of the light pipe, and k is a predetermined positive rational number.

The hollow has a cylindrical shape.

The prism section satisfies an equation,

$$L = 2 π r ( \begin{matrix}\frac{arc sin ( \frac{rn sin ( G + k )}{r - h} ) - arcsin ( n sin ( G + k ) )}{360} - \\ \frac{arcsin ( \frac{rn sin G}{r - h} ) - arcsin ( n sin G )}{360}\end{matrix} ) , \\ ( G = 0 , k , 2 k , 3 k , … , and N )$$

In this case, G represents the vertical angle, L represents a length of duration in the body having the angle adjusting section with the vertical angle G, r represents a radius of a cross section of the hollow, n represents a refractive index of the light pipe, k is a predetermined positive rational number, and h represents a distance between the light source to a point corresponding to an incident angle of 0° onto the internal surface of the body.

A cross section of the hollow is a figure formed by combining two same circular arcs to each other.

The prism section satisfies an equation,

$$L = 2 π r ( \begin{matrix}\frac{arc sin ( \frac{rn sin ( G + k )}{r - h} ) - arcsin ( n sin ( G + k ) )}{360} - \\ \frac{arcsin ( \frac{rn sin G}{r - h} ) - arcsin ( n sin G )}{360}\end{matrix} ) , \\ ( G = 0 , k , 2 k , 3 k , … , and N )$$

In this case, G represents the vertical angle, L represents a length of duration in the body having the angle adjusting section with the vertical angle G, r represents a radius of the circular arc, n represents a refractive index of the light pipe, k is a predetermined positive rational number, and h represents a distance between the light source to a point corresponding to an incident angle of 0° onto the internal surface of the body.

A cross section of the hollow is a figure formed by combining two same circular arcs facing each other and two same straight lines facing each other.

As described above, the light pipe according to the present invention has the following effects.

In other words, when the internal surface of the light pipe has a cylindrical shape, even if the light source is positioned off the center of the cross section of the light pipe, the light ray can travel while being total-reflected from the internal surface of the light pipe. Accordingly, it is possible to overcome a limitation that the light source must be installed at the center of the cross section of the light pipe. Therefore, the manufacturing efficiency of the light pipe can be increased.

According to the present invention, the internal surface of the light pipe can have various shapes as well as a cylindrical shape in a conventional technology, so that the light pipe can be used in various application fields such as a signboard and various displays. Accordingly, electric power can be saved, and light can be effectively transmitted to a remote place.

In addition, the present invention can provide a light pipe that can be used for a signboard and various displays to which a conventional cylindrical light pipe cannot be applied. Particularly, when a rectangular prism-shape-light pipe is used in a fluorescent signboard, the electric power saving efficiency and the manufacturing efficiency can be increased.

### BRIEF DESCRIPTION OF DRAWINGS

FIG. 1 is a sectional view showing the path of light ray along a cylindrical light pipe employing triangular prisms according to the related art;

FIG. 2 is an enlarged sectional view showing the path of light ray when the light pipe employing the triangular prisms has an internal flat surface according to the related art;

FIG. 3 is a sectional view showing the range of total reflection in a rectangular-prism-shape light pipe employing the triangular prisms according to the related art;

FIG. 4 is an enlarged sectional view showing the path of light ray along a light pipe employing a prism section according to one embodiment of the present invention;

FIG. 5 is an enlarged sectional view showing the path of light ray along a light pipe employing a prism section according to another embodiment of the present invention;

FIG. 6 is an enlarged sectional view showing the path of light ray of a light pipe employing a prism formed by tilting a conventional triangular prism at a predetermined angle;

FIG. 7 is a perspective view showing the light pipe according to the first embodiment of the present invention;

FIG. 8 is a sectional view showing the light pipe according to the first embodiment of the present invention;

FIG. 9 is a sectional view showing the path of light ray along the light pipe according to the first embodiment of the present invention;

FIG. 10A is a perspective view showing the light ray traveling inside the light pipe according to the first embodiment of the present invention;

FIG. 10B is a perspective view showing the light ray traveling in a prism section of the light pipe according to the first embodiment of the present invention;

FIG. 10C is a longitudinal sectional view showing the light ray, which travels in the prism section of the light pipe according to the first embodiment of the present invention, on a YZ plane;

FIG. 10D is a cross sectional view showing the light ray, which travels in the prism section of the light pipe according to the first embodiment of the present invention, on a ZX plane;

FIG. 11 is a perspective view showing the light pipe according to a second embodiment of the present invention;

FIG. 12 is a sectional view showing the light pipe according to the second embodiment of the present invention;

FIG. 13 is a sectional view showing the path of light ray in the light pipe according to the second embodiment of the present invention;

FIG. 14 is a perspective view showing a light pipe according to a third embodiment of the present invention;

FIG. 15 is a sectional view showing the light pipe according to the third embodiment of the present invention;

FIG. 16 is a sectional view showing the path of light ray in the light pipe according to the third embodiment of the present invention;

FIG. 17 is a perspective view showing a light pipe according to a fourth embodiment of the present invention;

FIG. 18 is a sectional view showing the light pipe according to the fourth embodiment of the present invention; and

FIG. 19 is an exploded perspective view showing the structure of a light pipe according to a fifth embodiment of the present invention.

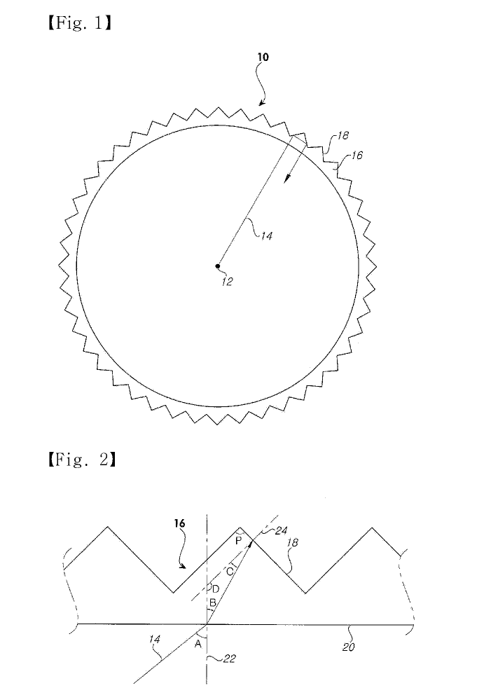

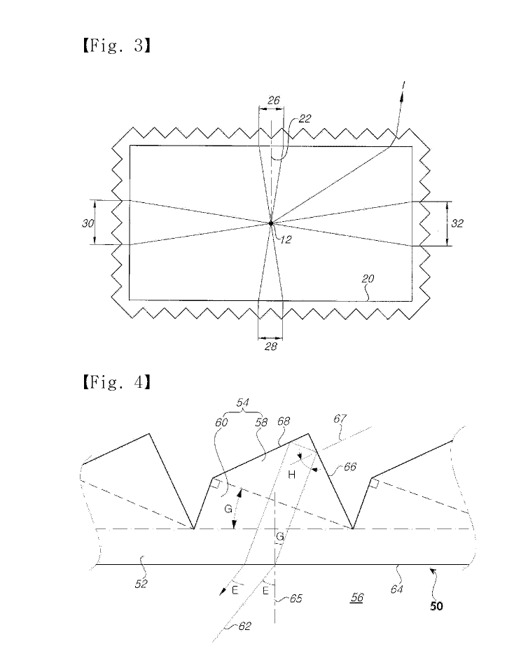

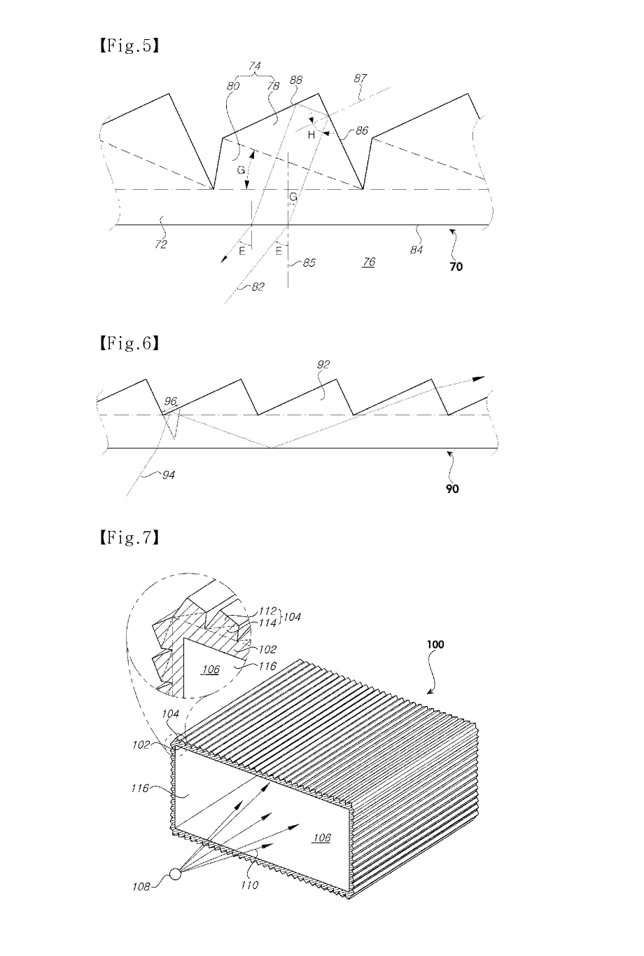

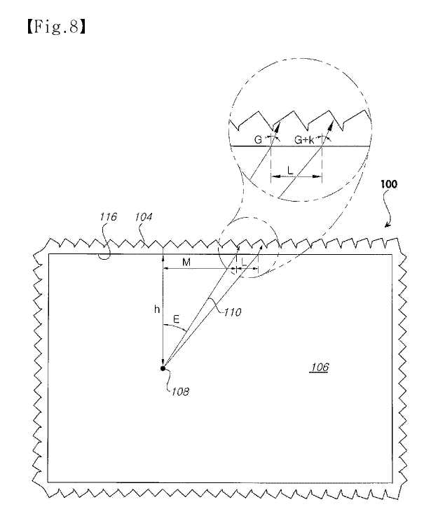

### DETAILED DESCRIPTION OF THE PREFERRED EMBODIMENTS

Hereinafter, a light pipe according to an exemplary embodiment of the present invention will be described in detail with reference to accompanying drawings.

FIGS. 4 to 19 are views showing a light pipe according to embodiments of the present invention.

In the following specification, an incident angle refers to an angle between an incident light ray and a boundary surface with a first medium when the light ray traveling into a second medium reaches the boundary surface with the first medium. A refracted angle refers to an angle between light ray refracted from the boundary surface and a normal line to the boundary surface.

Hereinafter, the structure of the light pipe according to embodiments of the present invention will be described with reference to FIGS. 4 and 6.

FIG. 4 is an enlarged sectional view showing the path of light ray along a light pipe employing a prism section according to one embodiment of the present invention, and FIG. 5 is an enlarged sectional view showing the path of light ray along a light pipe employing a prism section according to another embodiment of the present invention. FIG. 6 is an enlarged sectional view showing the path of light ray of a light pipe employing a prism section formed by tilting a conventional triangular prism at a predetermined angle.

As shown in FIG. 4, a light pipe 50 according to an embodiment of the present invention includes a body 52 and a prism section 54.

The body 52 is prepared in the form of a hollow tube in which a hollow 56 extends lengthwise along the body 52, and constitutes an inner part of the light pipe 52. A plurality of prism sections 54 are formed lengthwise along an outer surface of the body 52.

In this case, the prism section 54 has a rectangular cross section, and includes a reflection section 58 and an angle adjusting section 60.

In this case, the reflection section 58 corresponds to an isosceles right triangle when the cross section of the prism section 54 is divided into two right-angled triangles. In other words, the reflection section 58 has a shape obtained by tilting a triangular prism provided in a light pipe according to the related art by a predetermined angle.

In addition, the angle adjusting section 60 is interposed between the body 52 and the reflection section 58. The cross section of the angle adjusting section 60 is a right-angled triangle, and an oblique side of the right-angled triangle comes into contact with the body 52. The size of a vertical angle between the body 52 and the reflection section 58 varies depending on the position of a light source.

Hereinafter, detailed description will be made regarding the structure of the prism section 54 when light ray 62 emitted from the light source is incident into an internal surface 64 of the body 52 at an incident angle E.

If the light ray 62 emitted from the light source (not shown) forms an angle, that is, the incident angle E with a normal line 65 to the internal surface 64 of the body 52, a refracted angle G is obtained through Equation 3 under Snell's Law. In Equation 3, n represents a refractive index of the light pipe.

$$G = arcsin ( \frac{sin E}{n} ) \qquad Equation 3$$

In this case, an angle H between a normal line 67 to a prism surface 66 of the prism section 54 and the light ray 62 must be greater than a critical angle so that the light ray 62 is total-reflected on the prism surface 66. Accordingly, the condition of total reflection is represented as following Equation 4.

$$H > arcsin ( \frac{1}{n} ) \qquad Equation 4$$

After the light ray 62 has been total-reflected on the prism surface 66, the light ray 62 is again total-reflected on an adjacent prism surface 68 of the prism section 54 to travel through the hollow 56 of the light pipe 50. To cause total reflection on the adjacent prism surface 68, the light ray 62 must be incident into the adjacent prism surface 68 at an angle greater than the critical angle.

Accordingly, the angle H between the normal line 66 to the prism surface 66 and the light ray 62 is preferably 45° in order to total-reflect the light ray 62 on the prism surface 66, and then again total-reflect the light ray 62 on the adjacent prism surface 68.

If the angle H is 45°, the refractive index of polycarbonate, poly (methyl methacrylate), acryl, poly propylene, or poly styrene, poly (vinyl chloride) of the light pipe 50 according to an embodiment of the present invention satisfies Equation 4.

Since the cross section of the reflection section 58 is an isosceles right triangle, an angle formed between the cross section of the reflection section 58 and the cross section of the body 52 is equal to the refracted angle G at which the light ray 62 is refracted from the internal surface 64 of the body 52. In other words, the shape of the reflection section 58 corresponds to a shape obtained by tilting a structure having a cross section in the shape of an isosceles right triangle by the angle G.

Meanwhile, the angle G formed between the cross section of the reflection section 58 and the cross section of the body 52 is equal to the size of a vertical angle of the cross section of the angle adjusting section 60. In other words, the angle adjusting section 60 is interposed between the body 52 and the reflection section 58, and the vertical angle between the body 52 and the reflection section 58 in the cross section of the angle adjusting section 60 is equal to a refracted angle when the light ray 62 is incident into the internal surface 64 of the body 52 and refracted. Accordingly, the shape of the angle adjusting section 60 varies depending on the relative position between the light source and the internal surface 64 of the light pipe 50.

When the incident angle E of the light ray 62 has a value in the range of 0° to 90°, the refracted angle G has a value in the range of 0° to the critical angle. Accordingly, the vertical angle of the right-angled triangle corresponding to the cross section of the angle adjusting section 60 has the range represented in Equation 5.

$$0 < G < arcsin ( \frac{1}{n} ) \qquad Equation 5$$

Meanwhile, as the prism section 54 is designed in small size, the transmission efficiency of light may be increased, and the weight of the light pipe 50 may reduced.

The light pipe 50 including the prism section 54 may be made of materials, such as polycarbonate, poly (methyl methacrylate), acryl, poly propylene, poly styrene, or poly (vinyl chloride), representing superior light transmittance or mechanical stability.

The material of the light pipe 50 may be determined according to the type of a used light source. For example, if the light source of the light pipe 50 is a point light source, such as a mercury lamp or a metallic lamp, representing high efficiency, polycarbonate having strong heat resistance may be used as a material of the light pipe 50 when taking into consideration the temperature of heat emitted from the light source.

As shown in FIG. 5, a light pipe 70 according to another embodiment of the present invention includes a body 72 and a prism section 74.

The body 72 is prepared in the form of a hollow tube in which a hollow 56 extends lengthwise along the body 72, and constitutes an inner part of the light pipe 70. A plurality of prism sections 74 are formed lengthwise along an outer surface of the body 72.

In this case, the prism section 74 has a rectangular cross section, and includes a reflection section 78 and an angle adjusting section 80.

In this case, the reflection section 78 corresponds to an isosceles right triangle when the cross section of the prism section 74 is divided into two isosceles triangles. In other words, the reflection section 58 has a shape obtained by tilting a triangular prism provided in a light pipe according to the related art by a predetermined angle.

In addition, the angle adjusting section 80 is interposed between the body 72 and the reflection section 78, and the cross section of the angle adjusting section 80 is configured as an isosceles triangle having a vertical angle determined according to the position of the light source. In other words, the cross section of the angle adjusting section 80 is an isosceles triangle in which two sides of the isosceles triangle make contact with the body 72 and the reflection section 78 and have the same length, and a vertical angle of the isosceles triangle is interposed between the body 72 and the reflection section 78 and determined according to the position of the light source.

Hereinafter, detail description will be made regarding the structure of the prism section 74 while taking into consideration a casein which light ray 82 emitted from the light source is indent onto an internal surface 84 of the body 72 at an incident angle E.

If an angle formed between the light ray 82 emitted from the light source (not shown) and a normal line 85 to the internal surface 84 of the body 72, that is, an incident angle is E, a refracted angle G is obtained through Equation 3 under Snell's Law. In Equation 3, n represents the refractive index of the light pipe 70.

To enable the light ray 82 to be total-reflected from a prism surface 86 of the prism section 74, an angle H formed between the normal line 87 of the prism surface 86 and the light ray 82 must be greater than a critical angle. Accordingly, the condition of total reflection is represented through Equation 4.

After the light ray 82 has been total-reflected from the prism surface 86, the light ray 82 is again total-reflected from an adjacent prism surface 88 of the prism section 74 and directed to the hollow 76 of the light pipe 70. In this case, similarly, the light ray 82 must be incident into the adjacent prism surface 88 at an incident angle greater than the critical angle such that the total reflection again occurs on the prism surface 88.

Accordingly, the angle H formed between the normal line 87 to the prism surface 86 and the light ray 82 is preferably 45° such that the light ray 82 is total-reflected from the prism surface 88 and again total-reflected from the adjacent prism surface 88.

If the angle H is 45°, the refractive index n of polycarbonate, poly (methyl methacrylate), acryl, poly propylene, or poly styrene, poly (vinyl chloride) of the light pipe 70 according to another embodiment of the present invention satisfies Equation 4.

Since the cross section of the reflection section 88 is an isosceles right triangle, an angle formed between the cross section of the reflection section 78 and the cross section of the body 72 is equal to the refracted angle G at which the light ray 82 is refracted from the internal surface 84 of the body 72. In other words, the shape of the reflection section 88 corresponds to a shape obtained by tilting a structure having a cross section in the shape of an isosceles right triangle by the angle G.

Meanwhile, the angle G formed between the cross section of the reflection section 78 and the cross section of the body 72 is equal to the size of a vertical angle the cross section of the angle adjusting section 80. In other words, the angle adjusting section 80 is interposed between the body 72 and the reflection section 78, and the vertical angle between the body 72 and the reflection section 78 in the cross section of the angle adjusting section 80 is equal to a refracted angle when the light ray 82 is incident into the internal surface 84 of the body 72 and refracted. Accordingly, the shape of the angle adjusting section 80 varies depending on the relative position between the light source and the internal surface 84 of the light pipe 70.

When the incident angle E of the light ray 82 has a value in the range of 0° to 90°, the refracted angle G has a value in the range of 0° to the critical angle. Accordingly, the vertical angle of the isosceles triangle corresponding to the cross section of the angle adjusting section 80 has the range represented in Equation 5.

Meanwhile, as the prism section 74 is designed in small size, the transmission efficiency of light may be increased, and the weight of the light pipe 70 may reduced.

The light pipe 70 including the prism section 74 may be made of materials, such as polycarbonate, poly(methyl methacrylate), acryl, poly propylene, poly styrene, or poly(vinyl chloride), representing superior light transmission or mechanical stability.

The material of the light pipe 70 may be determined according to the type of a used light source. For example, if the light source of the light pipe 70 is a point light source, such as mercury lamp or metallic lamp having high efficiency, polycarbonate having strong heat resistance may be used as a material of the light pipe 70 when taking into consideration the temperature of heat emitted from the light source.

FIG. 6 is an enlarged sectional view showing the path of light ray of a light pipe employing a prism formed by tilting a conventional triangular prism at a predetermined angle.

Referring to FIG. 6, when a prism 92 applied to a light pipe 90 has a shape obtained by tilting a conventional triangular prism by a predetermined angle, if light ray 94 emitted from a light source (not shown) and incident into the light pipe 90 is primarily total-reflected from an extension section 96 of the conventional triangular prism, the light ray is not continuously total-reflected, but is emitted to the outside.

Accordingly, the prism section 54 or 74 according to an embodiment of the present invention has a rectangular cross section without the section 96, and is formed by combining the reflection section 58 or 78 having a cross section in the shape of an isosceles right triangle depending on the relative position between the light source and the internal surface 64 or 84 of the light pipe 50 or 70 with the angle adjusting section 60 or 80 having a cross section in the shape of a right-angled triangle or an isosceles triangle, so that the total reflection can continuously occur.

Hereinafter, the structure of a light pipe according to a first embodiment of the present invention will be described with respect to FIGS. 7 to 10.

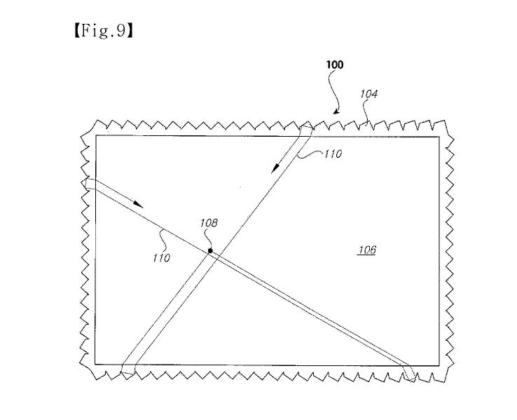

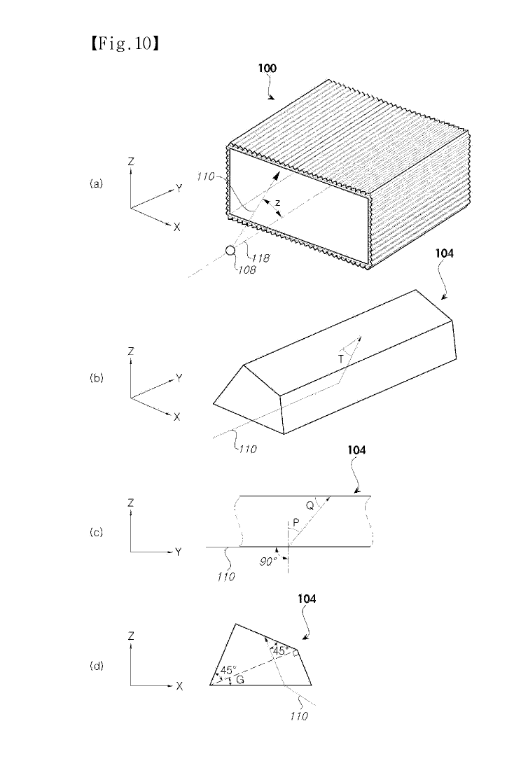

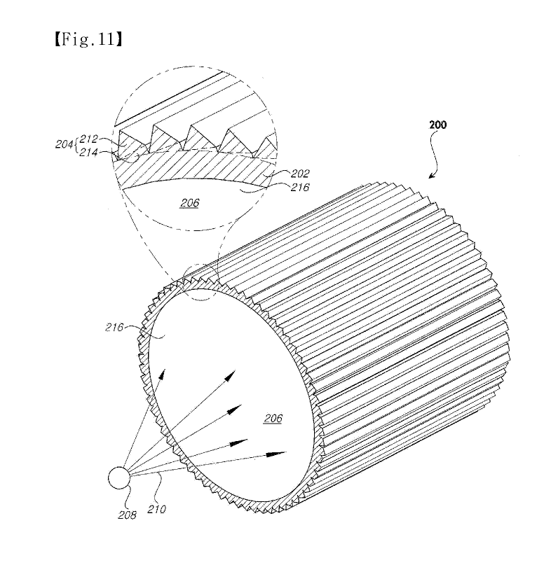

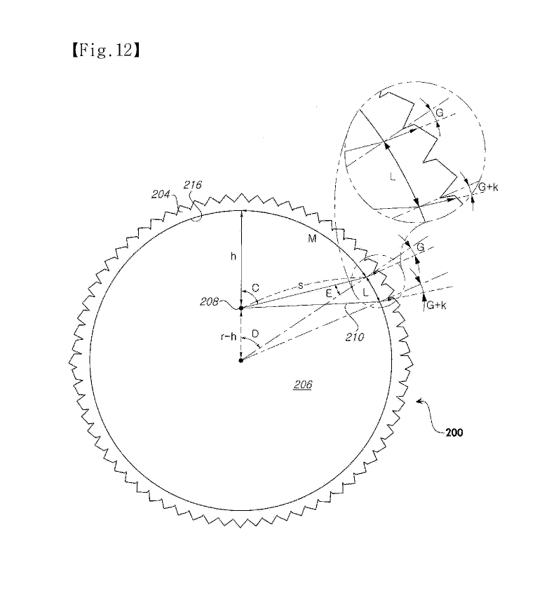

FIG. 7 is a perspective view showing the light pipe according to the first embodiment of the present invention, and FIG. 8 is a sectional view showing the light pipe according to the first embodiment of the present invention. FIG. 9 is a sectional view showing the path of light ray along the light pipe according to the first embodiment of the present invention. FIG. 10A is a perspective view showing the light ray traveling inside the light pipe according to the first embodiment of the present invention, and FIG. 10B is a perspective view showing the light ray traveling in a prism section of the light pipe according to the first embodiment of the present invention. FIG. 10C is a longitudinal sectional view showing the light ray, which travels in the prism section of the light pipe according to the first embodiment of the present invention, on a YZ plane. FIG. 10D is a cross sectional view showing the light ray, which travels in the prism section of the light pipe according to the first embodiment of the present invention, on a ZX plane.

FIGS. 8 and 9 are sectional views showing the light pipe according to the first embodiment of the present invention, in which only the light components of a light ray parallel to a cross section of the light pipe traveling in the light pipe are illustrated.

Referring to FIG. 7, a light pipe 100 according to a first embodiment of the present invention includes a body 102 and a prism section 104. The body 102 is prepared in the form of a hollow tube in which a hollow 106 extends lengthwise along the body 102. A plurality of prism sections 104 are formed lengthwise along an outer surface of the body 102. Each prism section 104 includes a reflection section 112 and an angle adjusting section 114.

The light ray 110, which has been emitted from a light source 108 and incident into the hollow 106 of the light pipe 100, is incident into an internal surface 116 of the light pipe 100 and then total-reflected from the prism section 104 under a total-reflection condition according to Snell's Law. The procedure is repeated, so that the light ray 110 travels lengthwise along the light pipe 100.

In addition, since the hollow 106 of the light pipe 100 is filled with air, the light ray 110 can travel lengthwise along the light pipe 100 without transmission loss.

The light pipe 100 according to the first embodiment of the present invention is different from a conventional light pipe in that the hollow 106 of the light pipe 100 has the shape of a rectangular prism.

Meanwhile, in the light pipe 100 according to the first embodiment of the present invention, the shape of the prism section 104 varies according to the relative position between the internal surface 116 of the body 102 of the light pipe 100 and the light source 108.

The size of a vertical angle between the body 102 and the reflection section 112 in a right angle triangle that corresponds to a cross section of the angle adjusting section 114 constituting the prism section 104 is identical to the size of a refracted angle obtained when the light ray 110 incident into the internal surface 116 of the body 102 while traveling in parallel to the cross section of the light pipe 100 is refracted. The refracted angle of the light ray 110 is determined according to the refractive index of the light pipe 100 and the incident angle of the light ray 110, and the size of the incident angle varies according to the relative position between the light source 108 and the internal surface 116 of the body 102.

Hereinafter, the shape of the prism section 104 varying according to the relative position between the light source 108 and the internal surface 116 of the body 102 will be described in detail with reference to FIG. 8.

An incident angle E corresponding to a refracted angle G of 0°, 1°, 2°, 3°, . . . and N° can be calculated by using the refractive index n of the light pipe 100. In addition, a distance M from a point where the incident angle of the light ray is 0° to a point where the incident angle of the light ray is E can be obtained by using a distance h between the light source 108 and the point where the incident angle of the light ray incident into the internal surface 116 of the body 102 is 0°. On the assumption that a refracted angle is defined as Gin the duration between a point where the refracted angle is G and a point where a refracted angle is G+1°, a length L of the duration having the refracted angle G can be obtained by using the distance M.

In this case, since the size of a vertical angle between the body 102 and the reflection section 112 in the cross section of the angle adjusting section 114 is equal to the refracted angle G of the light ray 110, the length L of the duration at which the vertical angle is G may be expressed as a generalized formula. The procedure to find the duration length L is expressed through following Equation 6.

sin E=n sin G

E=arcsin(n sin G)

M=h tan E

M=h tan [arcsin(n sin G)], (G=0, 1, 2, 3, . . . , and N)

L=h tan [arcsin(n sin(G+1)−arcsin(n sinG)], (G=0, 1, 2, 3, and N) Equation 6

Although the present invention has been described about a case in which G is 0°, 1°, 2°, 3°, . . . and N°, on the assumption that k is a positive rational number, the length L of the duration at which the vertical angle is G when the refracted angle G is increased by k° may be expressed as a generalized formula, and expressed through Equation 7.

L=h tan [arcsin(n sin(G+k)−arcsin(n sin G)], (G=0, k, 2k, 3k, . . . , and N) Equation 7

Meanwhile, for Example, if the Refractive Index N of the Light pipe 100 according to the first embodiment of the present invention is 1.57, and the refracted angle G is 0°, 1°, 2° and N° the incident angle E, the length M, and the duration length L have result values shown in Table 1.

TABLE 1

| Refracted angle G | Incident angle E | | Duration |
|---|---|---|---|
| (unit °) | (unit °) | Distance M | length L |
| 0 | 0 | 0 | 0.027 h |
| 1 | 1.57 | 0.027 h | 0.028 h |
| . | . | . | . |
| . | . | . | . |
| . | . | . | . |
| 5 | 7.86 | 0.138 h | 0.028 h |
| . | . | . | . |
| . | . | . | . |
| . | . | . | . |
| 10 | 15.82 | 0.283 h | 0.031 h |
| . | . | . | . |
| . | . | . | . |
| . | . | . | . |
| 15 | 23.97 | 0.445 h | 0.035 h |
| . | . | . | . |
| . | . | . | . |
| . | . | . | . |
| 20 | 32.48 | 0.636 h | 0.044 h |
| . | . | . | . |
| . | . | . | . |
| . | . | . | . |

As described above, in the light pipe 100 according to the first embodiment of the present invention, the size of the vertical angle between the body 102 and the reflection section 112 in the right-angled triangle that is the cross section of the angle adjusting section 114 is determined by using both the refractive index n of the light pipe 100 and the distance h between the light source 108 and the internal surface 116 of the body 102. Accordingly, when the cross section of the hollow 106 of the light pipe 100 has a polygonal shape, the calculation procedure is identically applied.

Meanwhile, in the light pipe 100 according to the first embodiment of the present invention, when the light source 108 is positioned at the center of the cross section of the hollow 106, prism sections 104 are arranged in the same form on two facing surfaces of the light pipe 100. In addition, if the cross section of the hollow 106 has a square shape, and the light source 108 is positioned at the center of the cross section of the hollow 106, prism sections 104 are arranged in the same form on four surfaces of the light pipe 100.

In contrast, if the light source 108 is positioned off the center of the cross section of the hollow 106, the arrangement of the prism sections 104 on the four surfaces of the light pipe 100 varies depending on the distance h from the light source 108 to the internal surface 116 of the body 102.

Hereinafter, the path of the light lay 110 in the light pipe 100 according to the first embodiment of the present invention will be described with reference to FIG. 9.

As shown in FIG. 9, the light ray 110 emitted from the light source 108 is incident into the light pipe 100 and total reflected from the prism section 104 under a total-reflection condition according to Snell's Law. The light ray 110 that has been total-reflected from the prism section 104 is incident into an opposite prism section 104 at the same incident angle and again total reflected from the opposite prism section 104, such that the light ray 110 travels lengthwise along the light pipe 100.

In other words, after the light ray 110 has been total reflected from the first incident surface, the light ray 110 is incident into a surface facing the first incident surface or a surface adjacent to the first incident surface at the same incident angle as that onto the first incident surface, such that total reflection occurs again. Accordingly, the light ray 110 travels lengthwise along the light pipe 100 while being continuously total-reflected from the prism sections 104.

Hereinafter, an allowance range for total reflection when the light ray 110 emitted from the light source 108 travels while forming a predetermined angel with a central line 118 of the light pipe 100 will be described with reference to FIGS. 10A to 10D.

Referring to FIG. 10A, when the light ray 110 travels while forming an angle Z with the central line 118 of the light pipe 100, if the angle Z is 90°, the incident angle of the light ray 110 on a prism surface of the prism section 104 is 45°.

Meanwhile, referring to FIG. 10B, when the angle Z approximates 0°, the light ray 110 is incident while traveling in substantially parallel to a longitudinal direction of the prism section 104. The light ray 110 is refracted from the internal surface 116 of the body 102 of the light pipe 100 so that the light ray 110 forms an angle T with respect to the prism surface of the prism section 104.

Referring to FIGS. 10C and 10D, since the light ray 110 is incident into the light pipe 100 at an incident angle of about 90° on a ZY plane, the refracted angle P is approximately equal to the critical angle. Accordingly, when only a ZY component of the light ray 110 is analyzed on the ZY plane, the refracted angle P of the light ray 110 can be found according to Snell's Law, an angle Q between the prism surface and the light ray 110 can be found by using the refracted angle P. The refracted angel P and the angel of Q are found through Equation 8.

$$P = arcsin ( \frac{1}{n} ) \\ Q = 90 - arcsin ( \frac{1}{n} ) \qquad Equation 8$$

In addition, when only a ZX component of the light ray 110 is analyzed on the ZX plane, the light ray 110 forms an angle of 45° with the prism surface.

In this case, if the angle Q is 90°, the angle T in FIG. 10B is identical to the angel of 45° in FIG. 10D. In addition, if the angle Q is 0°, the angle T in FIG. 10B is always 0° regardless of the angle of 45° in FIG. 10D. Accordingly, the angle T is proportional to the angle Q. Accordingly, the angle T and an incident angle H of the light ray 110 onto the prism surface can be found through Equation 9.

$$T = \frac{45 Q}{90} = \frac{1}{2} Q \\ T = \frac{1}{2} [ 90 - arcsin ( \frac{1}{n} ) ] \\ H = 90 - T \\ H = 90 - \frac{1}{2} [ 90 - arcsin ( \frac{1}{n} ) ] = 45 + \frac{1}{2} arcsin ( \frac{1}{n} ) \qquad Equation 9$$

Meanwhile, an angle Z between the light ray 110 and the central line 118 of the light pipe 100 is within the range of 0° to 90°. As described above, if the angle Z is 90°, the incident angle H is 45. If the angle Z 0°, the incident angle H can be found through Equation 9. Accordingly, if the angle Z is within the range of 0° to 90°, the range of the incident angle H is identical to that shown in Equation 10, and this satisfies the condition of total reflection as shown in FIG. 10.

$$45 \leq H \leq 45 + \frac{1}{2} arcsin ( \frac{1}{n} ) ( 0 \leq z \leq 90 ) \\ H > arcsin ( \frac{1}{n} ) \qquad Equation 10$$

In this case, the n is a refractive index according to the material of the light pipe 100. The incident angle H satisfies Equation 10 with respect to polycarbonate, poly(methyl methacrylate), acryl, poly propylene, poly styrene, or poly(vinyl chloride) that is a material of the light pipe 100.

Accordingly, in the light pipe 100 according to the first embodiment of the present invention, since the angle Z satisfies the range of 0° to 90°, all light rays 110 emitted from the light source 108 satisfies the total-reflection condition.

If the n is 1.57, since the incident angle H of the light ray 110 onto the prism surface of the prism section 104 exists between 45° and 64.78°, the incident angle H satisfies the total-reflection condition, that is, H>39.56°.

In addition, although the calculation procedure is not performed through the equations as described above, if the angle Z is 90°, the incident angle H may have the minimum value. As the angle Z is reduced, the incident angle H is gradually increased. Accordingly, if the incident angle H satisfies the total-reflection condition when the angle Z is 90°, the light ray 110 satisfies the total-reflection condition at all points of the prism section 104.

Hereinafter, the structure of a light pipe according to a second embodiment of the present invention will be described with reference to FIGS. 11 to 13.

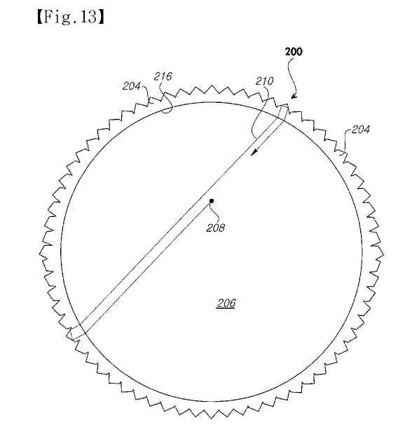

FIG. 11 is a perspective view showing the light pipe according to the second embodiment of the present invention, and FIG. 12 is a sectional view showing the light pipe according to the second embodiment of the present invention. FIG. 13 is a sectional view showing the path of light ray in the light pipe according to the second embodiment of the present invention.

In this case, FIGS. 12 and 13 are sectional views showing the light pipe according to the second embodiment of the present invention, and show only components of a light ray parallel to a cross section of the light pipe traveling in the light pipe.

Referring to FIG. 11, a light pipe 200 according to the second embodiment of the present invention has the shape of a cylindrical hollow tube, and includes a body 202 and a prism section 204. The body 202 is prepared in the form of a hollow tube in which a hollow 206 extends lengthwise along the body 202. A plurality of prism sections 204 are formed lengthwise along an outer surface of the body 202. The prism section 204 includes a reflection section 212 and an angle adjusting section 214.

After light ray 210 has been emitted from the light source 208 and incident into the hollow 206 of the light pipe 200, the light ray 210 is incident into an internal surface 216 of the light pipe 200 and total-reflected from the prism section 204 under a total-reflection condition according to Snell's Law. The above procedure is repeated, so that the light ray 210 travels lengthwise along the light pipe 200.

Since the hollow 206 of the light pipe 200 is filled with air, the light ray 210 can travel lengthwise along the light pipe 200 without transmission loss.

The light pipe 200 according to the second embodiment of the present invention is different from the conventional light pipe in that the light source 208 is positioned off the center of a cross section of the light pipe 200.

Meanwhile, in the light pipe 200 according to the second embodiment of the present invention, the shape of the prism section 204 varies according to the relative position between the light source 208 and the light pipe 200.

The size of a vertical angle between the body 202 and the reflection section 212 in a right-angled triangle that is a cross section of an angle adjusting section 214 constituting the prism section 204 is equal to the size of a refracted angle obtained when the light ray 210 incident into the internal surface 216 of the body 202 while traveling in parallel to the cross section of the light pipe 200 is refracted. The refracted angle of the light ray 210 varies according to the refractive index of the light pipe 200 and an incident angle of the light ray 210. The size of the incident angle varies according to a relative position between the light source 208 and the internal surface 216 of the body section 202.

Hereinafter, the shape of the prism section 204 varying according to the relative position between the light source 208 and the internal surface 216 of the body section 202 will be described in detail with reference to FIG. 12.

When the refracted angle G is 0°, 1°, 2°, 3°, . . . and N° the incident angle E can be found by using the refractive index n. In addition, the length M of an arc between a point corresponding to the incident angle of 0° onto the internal surface 216 of the body 202 and a point corresponding to the incident angle E can be found by using a distance h between the light source 208 and the point corresponding to the incident angle of 0°, a radius r of the cross section of the hollow 206, a distance s between the light source 208 and a point corresponding to the incident angle E, an angle C between a line linking the light source 208 with the point corresponding to the incident angle of 0° and a line linking the light source 208 with the point corresponding to the incident angle E, and an angle D between a line linking a center of a circle, which is the shape of the cross section of the hollow 206, with the point corresponding to the incident angle of 0° and a line linking the center of the circle with the point corresponding to the incident angle E. In addition, on the assumption that a refracted angel is defined as G in the duration between a point where the refracted angle is G and a point where a refracted angle is G+1°, the length L of the duration having the refracted angle G can be obtained by using the length M of the arc.

In this case, since the size of a vertical angle between the body 202 and the reflection section 212 in a right-angled triangle, which is a cross section of the angle adjusting section 214, is equal to the refracted angle G of the light ray 210, the length L of a duration in which the vertical angle is the refracted angle G may be expressed as a generalized formula. The procedure to find the length L is expressed through following Equation 11.

$$sin E = n sin G \\ E = C - D = arcsin ( n sin G ) \\ s sin C = r sin D \\ s sin E = ( r - h ) sin D \\ C = arcsin ( \frac{r sin E}{r - h} ) \\ D = C - ( C - D ) \\ D = arcsin ( \frac{rn sin G}{r - h} ) - arcsin ( n sin G ) \\ M = 2 π r ( \frac{D}{360} ) \\ M = 2 π r \frac{arcsin ( \frac{rn sin G}{r - h} ) - arcsin ( n sin G )}{360} \\ L = 2 π r ( \begin{matrix}\frac{\begin{matrix}arc sin ( \frac{rn sin ( G + 1 )}{r - h} ) - \\ arcsin ( n sin ( G + 1 ) )\end{matrix}}{360} - \\ \frac{arcsin ( \frac{rn sin G}{r - h} ) - arcsin ( n sin G )}{360}\end{matrix} ) , \\ G = 0 , 1 , 2 , 3 , … , and N \qquad Equation 11$$

Although the present invention has been described about a case in G is 0°, 1°, 2°, 3°, . . . and N°, on the assumption that k is a positive rational number, the length L of the duration at which the vertical angle is the refracted angle G when the refracted angle G is increased by k° may be expressed as a generalized formula, and expressed through Equation 12.

$$L = 2 π r ( \begin{matrix}\frac{\begin{matrix}arc sin ( \frac{rn sin ( G + k )}{r - h} ) - \\ arcsin ( n sin ( G + k ) )\end{matrix}}{360} - \\ \frac{arcsin ( \frac{rn sin G}{r - h} ) - arcsin ( n sin G )}{360}\end{matrix} ) , \\ G = 0 , k , 2 k , 3 k , … , and N \qquad Equation 12$$

As described above, in the light pipe 200 according to the second embodiment of the present invention, the shape of the prism section 204 varies according to the refractive index n, a distance h between the light source 208 and a point where an incident angle onto the internal surface 216 of the body 202 is 0°, and a radius r of the cross section of the hollow 206.

Hereinafter, the path of the light ray 210 in the light pipe 200 according to the second embodiment of the present invention will be described with reference to FIG. 13.

As shown in FIG. 13, the light ray 210 emitted from the light source 208 is incident into the light pipe 200 and reflected from prism section 204 under a total-reflection condition according to Snell's Law. The light ray 210 that has been total-reflected from the prism section 204 is again total-reflected from an opposite prism section 204 at the same angle, so that the light ray 210 travels lengthwise along the light pipe 200.

After the light ray 210 has been total-reflected from the first incident surface, the light ray 210 is incident into an incident surface opposite to the first incident surface at an incident angle the same as that of the first incident surface and again total reflected. Accordingly, the light ray 210 is continuously total-reflected from the prism section 204 while traveling lengthwise along the light pipe 200.

Meanwhile, in the light pipe 200 according to the second embodiment of the present invention, if the light ray 210 travels while forming an angle of 90°, and an incident angle onto the prism section 204 satisfies the total-reflection condition, the light ray 210 satisfies the total-reflection condition at all points of the prism section 204 similarly to the case of the light pipe 100 according to the first embodiment of the present invention described with reference to FIG. 10.

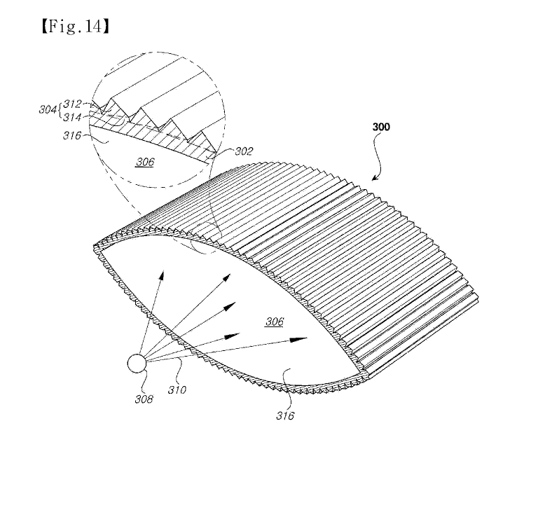

Hereinafter, the structure of the light pipe 300 having a hollow employing a figure, which is formed by combining two circular arcs with each other, as a cross section according to a third embodiment of the present invention will be described with reference to FIGS. 14 to 16.

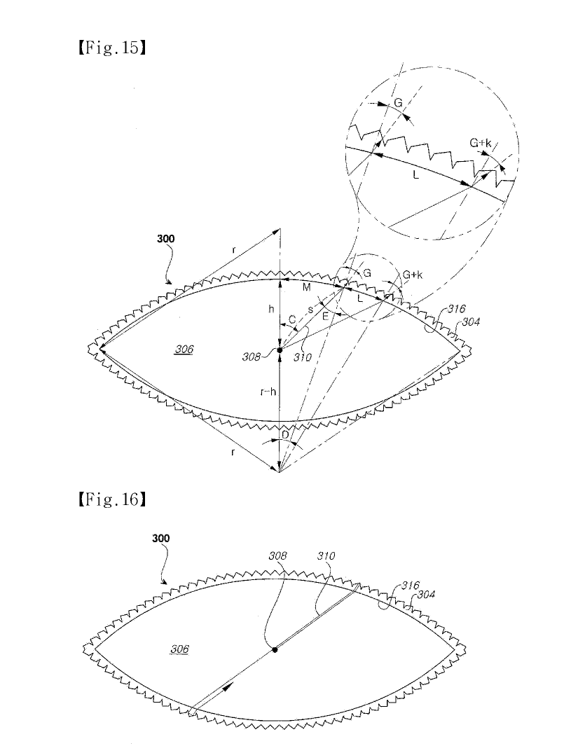

FIG. 14 is a perspective view showing a light pipe 300 according to the third embodiment of the present invention, and FIG. 15 is a sectional view showing the light pipe 300 according to the third embodiment of the present invention. FIG. 16 is a sectional view showing the path of light ray 310 in the light pipe 300 according to the third embodiment of the present invention.

In this case, FIGS. 15 and 16 are sectional views showing the light pipe 300 according to the third embodiment of the present invention, and show only components of light ray parallel to across section of the light pipe traveling in the light pipe.

Referring to FIG. 14, the light pipe 300 according to the first embodiment of the present invention includes a body 302 and a prism section 304. The body 102 is prepared in the form of a hollow tube in which a hollow 306 extends lengthwise along the body 102. The hollow 306 has the cross section in the shape of a figure formed by combining two same circular arcs with each other.

A plurality of prism sections 304 are formed lengthwise along an outer surface of the body 302. Each prism section 304 includes a reflection section 312 and an angle adjusting section 314.

The light ray 310 emitted from a light source 308 is total-reflected from the prism section 304 according to Snell's Law, and the above procedure is repeated, so that the light ray 310 travels lengthwise along the light pipe 300. Since the hollow 306 of the light pipe 300 is filled with air, the light ray 310 can travel without transmission loss.

The light pipe 300 according to the third embodiment of the present invention is different from the conventional light pipe in that the cross section of the hollow 306 has the shape of a figure formed by combining two same circular arcs.

Meanwhile, in the light pipe 300 according to the third embodiment of the present invention, the shape of the prism section 304 varies according to the relative position between the light source 308 and the light pipe 300.

The vertical angle between the body 302 and the reflection section 312 in a right-angled triangle that is a cross section of an angle adjusting section 314 constituting the prism section 304 is equal to the refracted angle of the light ray 310, which is obtained when the light ray 310 incident into the internal surface 316 of the body 302 while traveling in parallel to the cross section of the light pipe 300 is refracted. The refracted angle of the light ray 310 varies according to a refractive index of the light pipe 300 and an incident angle of the light ray 310. The size of the incident angle varies according to a relative position between the light source 308 and the internal surface 316 of the body section 302.

Hereinafter, the shape of the prism section 304 varying according to the relative position between the light source 308 and the internal surface 316 of the body 302 will be described with reference to FIG. 15.

When the refracted angle G is 0°, 1°, 2°, 3°, . . . and N° the incident angle E can be found by using the refractive index n of the light pipe 300. In addition, the length M of an arc between a point corresponding to the incident angle of 0° onto the internal surface 316 of the body 302 and a point corresponding to the incident angle E can be found by using a distance h between the light source 308 and the point corresponding to the incident angle of 0°, a curvature radius r of an arc constituting the cross section of the hollow 306, a distance s between the light source 308 and the point corresponding to the incident angle E, an angle C between a line linking the light source 308 with the point corresponding to the incident angle of 0° and a line linking the light source 308 with the point corresponding to the incident angle E, and an angle D between a line linking a curvature center of an arc constituting the cross section of the hollow 306 with the point corresponding to the incident angle of 0° and a line linking the curvature center with the point corresponding to the incident angle E. In addition, on the assumption a refracted angle is G in duration between a point where the refracted angle is G and a point wherein the refracted angle is G+1°, the length L of the duration having the refracted angle G can be obtained by using the length M of the arc.

In this case, since the size of a vertical angle between the body 302 and the reflection section 312 in a right-angled triangle, which is a cross section of the angle adjusting section 314, is equal to the refracted angle G of the light ray 310, the length L of a duration at which the vertical angle is equal to the refracted angle G may be expressed as a generalized formula. The procedure to find the length L is expressed through following Equation 13.

$$sin E = n sin G \\ E = C - D = arcsin ( n sin G ) \\ s sin C = r sin D \\ s sin E = ( r - h ) sin D \\ C = arcsin ( \frac{r sin E}{r - h} ) \\ D = C - ( C - D ) \\ D = arcsin ( \frac{rn sin G}{r - h} ) - arcsin ( n sin G ) \\ M = 2 π r ( \frac{D}{360} ) \\ M = 2 π r \frac{arcsin ( \frac{rn sin G}{r - h} ) - arcsin ( n sin G )}{360} \\ L = 2 π r ( \begin{matrix}\frac{\begin{matrix}arc sin ( \frac{rn sin ( G + 1 )}{r - h} ) - \\ arcsin ( n sin ( G + 1 ) )\end{matrix}}{360} - \\ \frac{arcsin ( \frac{rn sin G}{r - h} ) - arcsin ( n sin G )}{360}\end{matrix} ) , \\ G = 0 , 1 , 2 , 3 , … , and N \qquad Equation 13$$

Although the present invention has been described about a case in G is 0°, 1°, 2°, 3°, . . . and N° on the assumption that k is a positive rational number, the length L of the duration at which the vertical angle is the refracted angle G when the refracted angle G is increased by k° may be induced to a generalized formula, and expressed through Equation 14.

$$L = 2 π r ( \begin{matrix}\frac{\begin{matrix}arc sin ( \frac{rn sin ( G + k )}{r - h} ) - \\ arcsin ( n sin ( G + k ) )\end{matrix}}{360} - \\ \frac{arcsin ( \frac{rn sin G}{r - h} ) - arcsin ( n sin G )}{360}\end{matrix} ) , \\ G = 0 , k , 2 k , 3 k , … , and N \qquad Equation 14$$

As described above, in the light pipe 300 according to the third embodiment of the present invention, the shape of the prism section 304 varies according to the refractive index n, a distance h between the light source 308 and the point where an incident angle onto the internal surface 316 of the body 302 is 0°, and the curvature radius r of the arc constituting the cross section of the hollow 306.

Hereinafter, the path of the light ray 310 in the light pipe 300 according to the third embodiment of the present invention will be described with reference to FIG. 16.

As shown in FIG. 16, the light ray 310 emitted from the light source 308 is incident into the light pipe 300 and reflected from prism section 304 under a total-reflection condition according to Snell's Law. The light ray 310 that has been total-reflected from the prism section 304 is again total-reflected from an opposite prism section 304 at the same angle, so that the light ray 310 travels lengthwise along the light pipe 300.

After the light ray 310 has been total-reflected from the first incident surface, the light ray 310 is incident into an incident surface opposite to the first incident surface at an incident angle the same as that of the first incident surface and again total reflected. Accordingly, the light ray 310 is continuously total-reflected from the prism section 304 while traveling lengthwise along the light pipe 300.

Meanwhile, in the light pipe 300 according to the third embodiment of the present invention, if the light ray 310 travels while forming an angle of 90°, and an incident angle onto the prism section 304 satisfies the total-reflection condition, the light ray 310 satisfies the total-reflection condition at all points of the prism section 304 similarly to the case of the light pipe 100 according to the first embodiment of the present invention described with reference to FIG. 10.

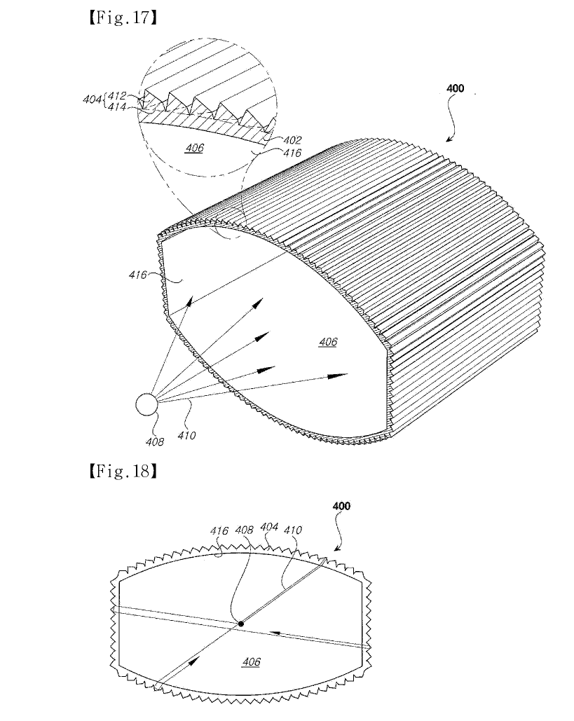

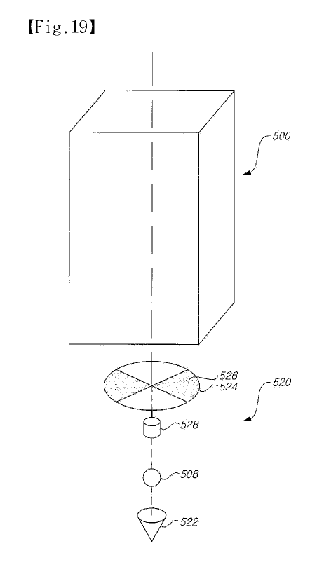

Hereinafter, the structure of the light pipe 400 having a hollow employing a figure, which is formed by combining two same circular facing each other and two same straight lines facing each other, as a cross section according to a third embodiment of the present invention will be described with reference to FIGS. 17 to 18.

FIG. 17 is a perspective view showing the light pipe 400 according to the fourth embodiment of the present invention, and FIG. 18 is a sectional view showing the light pipe 400 according to the fourth embodiment of the present invention.

In this case, FIG. 18 is a sectional view showing the light pipe 400 according to the fourth embodiment of the present invention, and show only components of light ray parallel to a cross section of the light pipe 400 traveling in the light pipe 400.

Referring to FIG. 17, the light pipe 400 according to the fourth embodiment of the present invention includes a body 402 and the prism section 404. The body 402 includes a hollow 406 formed through the light pipe 400 lengthwise along the light pipe 400. The cross section of the hollow 406 has a shape of a figure formed by combining two same circular arcs facing each other and two same straight lines facing each other.

A plurality of prism sections 404 are provided on an outer surface of the body 402, and each prism section 404 includes a reflection section 412 and an angle adjusting section 414.

The light ray 410 emitted from the light source 408 is total-reflected from the prism sections 404 under a total-reflection condition according to Snell's Law. Through the above procedure, the light ray 410 travels lengthwise along the light pipe 400. In addition, since the hollow 406 of the light pipe 400 is filled with air, the light ray 410 can travel without light loss.

The light pipe 400 according to the fourth embodiment of the present invention is different from the conventional light pipe in that the cross section of the hollow 406 has the shape of a figure formed by combining two same circular arcs facing each other and two same straight lines facing each other.

Meanwhile, in the light pipe 400 according to the fourth embodiment of the present invention, the shape of each prism section 404 varies according to the relative position between the light source 408 and the light pipe 400.

The size of a vertical angle between the body 402 and the reflection section 412 in a right-angled triangle that is a cross section of an angle adjusting section 414 constituting the prism section 404 is equal to the size of a refracted angle of the light ray 410 obtained when the light ray 410 incident into the internal surface 416 of the body 402 while traveling in parallel to the cross section of the light pipe 400 is refracted. The refracted angle of the light ray 410 varies according to a refractive index of the light pipe 400 and an incident angle of the light ray 410. The size of the incident angle varies according to a relative position between the light source 408 and the internal surface 416 of the body section 402.

Meanwhile, the shape of the prism section 404 varying according to the relative position between the light source 408 and the internal surface 416 of the body 402 are separately determined in a straight-line portion of the cross section of the hollow 406 and a circular-arc-portion of the cross section.

In other words, in the straight-line portion of the cross section of the hollow 406, the shape of the prism section 404 is determined through Equation 7 as shown in FIG. 8 similarly to the light pipe according to the first embodiment of the present invention. In the circular-arc-portion of the cross section of the hollow 406, the shape of the prism section 404 is determined through Equation 14 as shown in FIG. 15 similarly to the light pipe according to the third embodiment of the present invention.

Hereinafter, the path of the light ray 410 in the light pipe 400 according to the fourth embodiment of the present invention will be described with reference to FIG. 18.

As shown in FIG. 18, the light ray 410 emitted from the light source 408 is incident into the light pipe 400 and reflected from prism section 404 under a total-reflection condition according to Snell's Law. The light ray 410 that has been total-reflected from the prism section 404 is again total-reflected from an opposite prism section 404 at the same incident angle, so that the light ray 410 travels lengthwise along the light pipe 400.

After the light ray 410 has been total-reflected from the first incident surface, the light ray 410 is incident into an incident surface opposite to the first incident surface at an incident angle the same as that of the first incident surface and again total reflected. Accordingly, the light ray 410 is continuously total-reflected from the prism section 404 while traveling lengthwise along the light pipe 400.

Meanwhile, in the light pipe 400 according to the third embodiment of the present invention, if the light ray 410 travels while forming an angle of 90°, and an incident angle onto the prism section 404 satisfies the total-reflection condition, the light ray 410 satisfies the total-reflection condition at all points of the prism section 404 similarly to the case of the light pipe 100 according to the first embodiment of the present invention described with reference to FIG. 10.

When the light pipe 400 according to the fourth embodiment of the present invention is employed for a signboard, the light pipe 400 can be reduced in size and represent a superior outer appearance.

Meanwhile, although only the case in which the cross section of the angle adjusting section 114, 214, 314, or 414 has the shape of a right-angled triangle has been considered in the first to fourth embodiments of the present invention, the cross section of the angle adjusting section 114, 214, 314, or 414 may have the shape of an isosceles triangle as shown in FIG. 5. In this case, the size of the isosceles triangle constituting the cross section of the angle adjusting section 114, 214, 314, or 414 is equal to a refracted angle obtained when the light ray 110, 210, 310, or 410 incident into the internal surface 116, 216, 316, or 416 of the body 102, 202, 302, or 402 while traveling in parallel to the cross section of the light pipe 100, 200, 300, or 400 is refracted. Accordingly, the light ray 110, 210, 310, or 410 is continuously total-reflected while traveling lengthwise along the light pipe 100, 200, 300, or 400.

Hereinafter, the structure of a light pipe 500 according to a fifth embodiment of the present invention will be described with reference to FIG. 19.

FIG. 19 is an exploded perspective view showing the structure of the light pipe 500 according to the fifth embodiment of the present invention.

As shown in FIG. 19, the light pipe 500 according to the fifth embodiment of the present invention further includes a filter section 520 in addition to components of the light pipe according to the first embodiment to the fourth embodiment of the present invention. The filter section 520 transforms a color of light emitted from a light source 508.

The filter section 520 further includes a reflector 522 to reflect light ray emitted from the light source 508. The reflector 522 is positioned at one end of the light pipe 500 to reflect the light ray emitted from the light source 508 toward an opposite end of the light pipe 500.

In addition, the filter section 520 includes a color filter 524. The color filter 524 is provided at the front of the reflector 522, and includes at least one coloring layer 526. The color of light incident into the color filter 524 is changed when the light passes through the coloring layer 526.

The color filter 524 is a circular glass plate, and includes a dichroic filter which has been subject to dichroic coating, colored glass, or polycarbonate according to the use of the light pipe 500. For example, when taking into consideration the heat emitted from the light source 508 of the light pipe 500, the color filter 524 includes the dichroic filter which has been subject to the dichroic coating.

In addition, the filter section 520 includes a motor 528 to rotate the color filter 524. The motor 528 is used to convert the color of the light emitted to the outside of the light pipe 500 by rotating the color filter 524.

When the light pipe 500 according to the fifth embodiment of the present invention is used for a signboard or various displays, the light pipe 500 can be used as a device to covert white light emitted from the light source 508 into various color light. In other words, the light ray emitted from the light source 508 is transmitted into the color filter 524, so that the light pipe 500 can discharge various color light to the outside.

Since a prism section is arranged in parallel to the light pipe according to each embodiment of the present invention, the light pipe can be mass-produced through extrusion molding based on polycarbonate or acrylic resin, and the thickness of the light pipe can be determined within the range sufficient to maintain the shape of the light pipe and endure external shock according to the material characteristics of the light pipe.

When the light pipe according to each embodiment of the present invention is used for a signboard or a display, light must be uniformly emitted from the surface of the light pipe. When the light pipe has a short length, the light can be uniformly emitted from the surface of the light pipe. However, when the light pipe has a long length, the internal or external surface of the light pipe must be treated to be rough, or a light diffusion film is attached to the internal or external surface of the light pipe, so that total-reflected light can be emitted to the outside of the pipe.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A light pipe comprising:
a body provided therein with a hollow extending lengthwise along the body; and
a plurality of prism sections extending lengthwise along the body on an outer surface of the body,
wherein each prism section includes:
a reflection section, a cross section of which is an isosceles right triangle; and
an angle adjusting section interposed between the body and the reflection section.

2. The light pipe of claim 1, wherein a cross section of the angle adjusting section is a right-angled triangle having an oblique side in contact with the body and a vertical angle that is interposed between the body and the reflection section and determined according to a position of a light source.

3. The light pipe of claim 1, wherein a cross section of the angle adjusting section is an isosceles triangle that has two sides having a same length in contact with the body and the reflection section and a vertical angle that is interposed between the body and the reflection section and determined according to a position of a light source.

4. The light pipe of claim 2, wherein the vertical is equal to a refracted angle obtained when light ray emitted from the light source travels in parallel to a cross section of the light pipe, is indent into an internal surface of the body, and refracted.

5. The light pipe of claim 4, wherein the vertical angle satisfies an equation,
$$G = arcsin ( \frac{sin E}{n} ) ,$$
in which G, n, and E represent the vertical angle, a refractive index of the light pipe, and an incident angle when the light ray emitted from the light source travels in parallel to the cross section of the light pipe and incident into the internal surface of the body, respectively.

6. The light pipe of claim 4, wherein the light pipe further comprises a filter section to transform a color of light emitted from the light source, and
wherein the filter section includes:
a reflector to reflect the light ray emitted from the light source;
a color filter provided at a front of the reflector, including at least one coloring layer, and having a light transmission property; and
a motor to rotate the color filter.

7. The light pipe of claim 4, wherein the hollow has a polygonal shape.

8. The light pipe of claim 7, wherein the prism section satisfies an equation,
L=h tan [arcsin(n sin(G+k)−arcsin(n sin G)], (G=0, k, 2k, 3k, . . . , and N)
in which G represents the vertical angle, L represents a length of duration in the body having the angle adjusting section with the vertical angle G, h represents a distance between the light source to a point corresponding to an incident angle of 0° into the internal surface of the body, n represents a refractive index of the light pipe, and k is a predetermined positive rational number.

9. The light pipe of claim 4, wherein the hollow has a cylindrical shape.

10. The light pipe of claim 9, wherein the prism section satisfies an equation,
$$L = 2 π r ( \begin{matrix}\frac{arc sin ( \frac{rn sin ( G + k )}{r - h} ) - arcsin ( n sin ( G + k ) )}{360} - \\ \frac{arcsin ( \frac{rn sin G}{r - h} ) - arcsin ( n sin G )}{360}\end{matrix} ) , \\ ( G = 0 , k , 2 k , 3 k , … , and N )$$
, in which G represents the vertical angle, L represents a length of duration in the body having the angle adjusting section with the vertical angle G, r represents a radius of a cross section of the hollow, n represents a refractive index of the light pipe, k is a predetermined positive rational number, and h represents a distance between the light source to a point corresponding to an incident angle of 0° onto the internal surface of the body.

11. The light pipe of claim 4, wherein a cross section of the hollow is a figure formed by combining two same circular arcs to each other.

12. The light pipe of claim 11, wherein the prism section satisfies an equation,
$$L = 2 π r ( \begin{matrix}\frac{arc sin ( \frac{rn sin ( G + k )}{r - h} ) - arcsin ( n sin ( G + k ) )}{360} - \\ \frac{arcsin ( \frac{rn sin G}{r - h} ) - arcsin ( n sin G )}{360}\end{matrix} ) , \\ ( G = 0 , k , 2 k , 3 k , … , and N )$$
, in which G represents the vertical angle, L represents a length of duration in the body having the angle adjusting section with the vertical angle G, r represents a radius of the circular arc, n represents a refractive index of the light pipe, k is a predetermined positive rational number, and h represents a distance between the light source to a point corresponding to an incident angle of 0° onto the internal surface of the body.

13. The light pipe of claim 4, wherein a cross section of the hollow is a figure formed by combining two same circular arcs facing each other and two same straight lines facing each other.
